(19) United States
(12) Patent Application Publication
(10) Pub. No.: US 2021/0070565 A1
(43) Pub. Date: Mar. 11, 2021

(54) SHEET STORING DEVICE AND IMAGE PROCESSING APPARATUS

(71) Applicant: TOSHIBA TEC KABUSHIKI KAISHA, Tokyo (JP)

(72) Inventor: Mikio YAMAMOTO, Izunokuni Shizuoka (JP)

(21) Appl. No.: 16/566,445

(22) Filed: Sep. 10, 2019

(51) Int. Cl. B65H 1/18; G03G 15/00; B65H 29/52

(52) U.S. Cl. CPC B65H 1/18; B65H 29/52; G03G 15/6502

(57) ABSTRACT

A sheet storing device includes a sheet cassette and a sheet tray. The sheet cassette is for storing sheets. The sheet tray is at an inner bottom surface of the sheet cassette and rotatable around a shaft that is located along one end of the inner bottom surface in a sheet feed direction. An upper surface of the sheet tray on which the sheets are to be stored has a projection extending from a first end of the sheet tray towards a second end of the sheet tray, which is coupled to the shaft, such that the sheets on the upper surface are at least partially bent in an upward convex shape at a region above the projection.

### FIELD

Embodiments described herein relate generally to a sheet storing device, an image forming apparatus, and an image decoloring apparatus.

### BACKGROUND

An image processing apparatus, such as an image forming apparatus or an image decoloring apparatus, includes an image processing section and a sheet storing device. Sheets are conveyed from the sheet storing device to the image processing section one by one. There is a demand for a sheet storing device that can prevent inadvertent double sheet feeding in which multiple sheets are simultaneously conveyed.

### DESCRIPTION OF THE DRAWINGS

FIG. 1 is a schematic configuration diagram of an image processing apparatus according to a first embodiment.

FIG. 2 illustrates a side cross-sectional view of a sheet supplying section including a sheet storing device in the first embodiment.

FIG. 3 illustrates a plan view of the sheet storing device.

FIG. 4 illustrates a plan view of the sheet storing device.

FIG. 5 illustrates a front cross-sectional view of the sheet storing device.

FIG. 6 illustrates a plan view of a sheet storing device in a second embodiment.

FIG. 7 illustrates a side cross-sectional view of a sheet storing device in a third embodiment.

FIG. 8 illustrates an enlarged view of a front cross section of a sheet storing device in a fourth embodiment.

### DETAILED DESCRIPTION

A sheet storing device according to an embodiment includes a sheet cassette and a sheet tray. The sheet cassette is for storing sheets. The sheet tray is provided at an inner bottom surface of the sheet cassette and is rotatable around a shaft that is located along one end of the inner bottom surface in a sheet feed direction. An upper surface of the sheet tray on which the sheets are to be stored has a projection extending from a first end of the sheet tray towards a second end of the sheet tray that is coupled to the shaft towards, such that the sheets on the upper surface are at least partially bent in an upward convex shape at a region above the projection.

Sheet storing devices and image processing apparatuses according to example embodiments are described below with reference to the drawings.

### First Embodiment

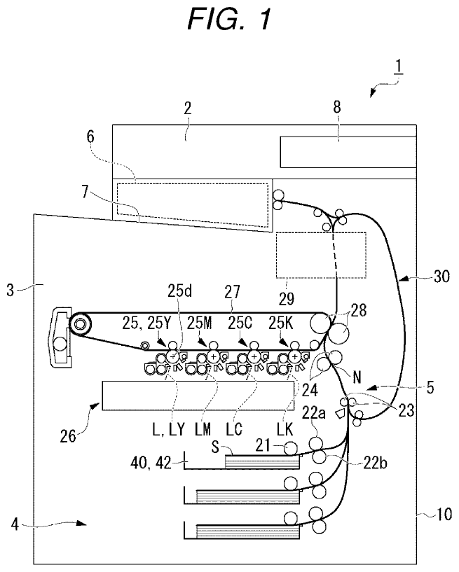

FIG. 1 is a schematic configuration diagram of an image processing apparatus according to a first embodiment.

The image processing apparatus according to the first embodiment is an image forming apparatus 1. The image forming apparatus 1 performs processing for forming an image on a sheet S. The image forming apparatus 1 includes a housing 10, a scanner section 2, an image forming unit 3 (also referred to as an image processing unit 3), a sheet supplying section 4, a conveying section 5, a reversing unit 30, a paper discharge tray 7, a control panel 8, and a control section 6.

The housing 10 forms the external shape of the image forming apparatus 1. The housing 10 partitions components of the image forming apparatus 1 on the inside of the image forming apparatus 1.

The scanner section 2 obtains image information of a copying target object based on brightness and darkness of light and generates an image signal. The scanner section 2 outputs the generated image signal to the image forming unit 3.

The image forming unit 3 applies image forming processing to the sheet S. The image forming unit 3 forms, based on the image signal received from the scanner section 2 or an image signal received from the outside, an output image with a developer containing toner and the like (hereinafter referred to as toner image). The image forming unit 3 transfers the toner image onto the surface of the sheet S. The image forming unit 3 applies heat and pressure to the toner image on the surface of the sheet S and fixes the toner image on the sheet S. That is, the image forming unit 3 applies the image forming processing to the sheet S. Details of the image forming unit 3 are described below.

The sheet supplying section 4 supplies sheets S to the conveying section 5 one by one according to timing when the image forming unit 3 forms the toner image.

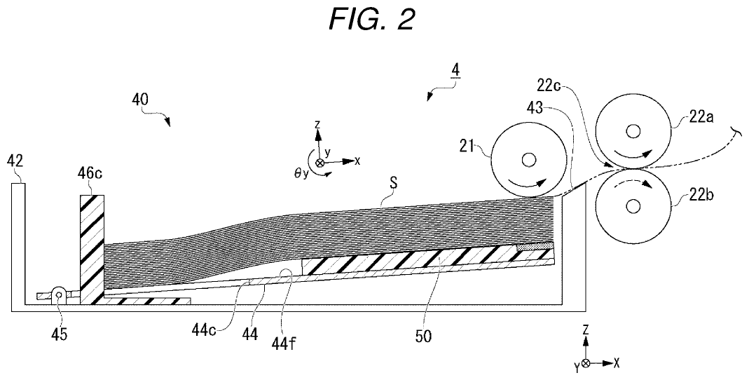

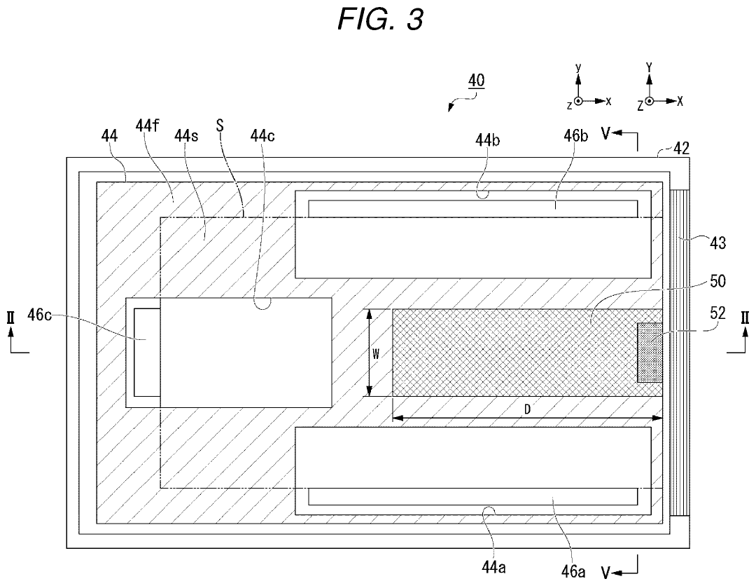

FIG. 2 illustrates a side cross-sectional view of the sheet supplying section including the sheet storing device in the first embodiment. FIG. 2 illustrates a cross-sectional view in a portion corresponding to a II-II line in FIG. 3.

As an overall coordinate system of the image forming apparatus 1, an X direction, a Y direction, and a Z direction are defined as follows. The X direction and the Y direction are horizontal directions and orthogonal to each other. A +X direction is a downstream side of a direction in which the sheet S is supplied from a sheet storing device 40. A center side in the Y direction of the sheet storing device 40 may be referred to as inner side in the Y direction. The Z direction is a vertical direction. A +Z direction is an upward direction.

The sheet supplying section 4 includes the sheet storing device 40, a pickup roller 21, a paper feeding roller 22a, and a separating roller 22b.

The sheet storing device 40 is detachably attachable to the image forming apparatus 1. Details of the sheet storing device 40 are described below.

The pickup roller 21 includes a high-friction material such as rubber on the outer circumferential surface thereof. The pickup roller 21 is disposed in the +Z direction of the sheet storing device 40 and is capable of approaching and separating from the sheet storing device 40. The pickup roller 21 is disposed near the end portion in the +X direction of the sheet storing device 40. The pickup roller 21 comes into contact with the upper surface of the sheet S stored in the sheet storing device 40. The pickup roller 21 rotates with a driving force of a not-illustrated motor and takes out the sheet S from the sheet storing device 40. A cassette 42 of the sheet storing device 40 includes an inclined surface 43 at the end portion in the +Z direction of a sidewall in the +X direction. The inclined surface 43 guides the sheet S taken out by the pickup roller 21 to the paper feeding roller 22a.

The paper feeding roller 22a and the separating roller 22b include high-friction materials such as rubber on the outer circumferential surfaces thereof. The paper feeding roller 22a and the separating roller 22b are disposed on the outer side in the +X direction of the sheet storing device 40. The paper feeding roller 22a is disposed in the +Z direction. The separating roller 22b is disposed in a −Z direction. The paper feeding roller 22a and the separating roller 22b are in contact with each other and form a nip 22c. The sheet S taken out by the pickup roller 21 is led into the nip 22c. The paper feeding roller 22a rotates with a driving force of a not-illustrated motor. The separating roller 22b rotates following the rotation of the paper feeding roller 22a. The paper feeding roller 22a supplies the sheet S led into the nip 22c to the conveying section 5 illustrated in FIG. 1.

The separating roller 22b is fixed to the housing 10 via a torque limiter. The pickup roller 21 takes out one sheet S from the sheet storing device 40 and leads the sheet S into the nip 22c. At this time, large torque acts on the separating roller 22b from the paper feeding roller 22a via the sheet S. The torque limiter of the separating roller 22b blocks torque transmission. The separating roller 22b idles (rotates following the rotation of the paper feeding roller 22a). Consequently, the one sheet S is supplied to the conveying section 5.

In some case, the pickup roller 21 may take out two or more superimposed sheets S and lead the sheets S into the nip 22c. A coefficient of friction between an upper layer sheet and a lower layer sheet is small compared with a coefficient of friction between the paper feeding roller 22a and the separating roller 22b and the sheet S. If a conveying force acts on the upper layer sheet from the paper feeding roller 22a, a slip may occur between the upper layer sheet and the lower layer sheet. Therefore, the intended torque may not act on the separating roller 22b from the paper feeding roller 22a. Since the torque limiter does not block the torque transmission, the separating roller 22b comes to a standstill. Consequently, the lower layer sheet stops in the nip 22c together with the separating roller 22b. Only the upper layer sheet is supplied to the conveying section 5 by the paper feeding roller 22a. Therefore, the separating roller 22b has a function of preventing double feeding of the sheets S.

As illustrated in FIG. 1, the conveying section 5 conveys the sheet S supplied from the sheet supplying section 4 to the image forming unit 3. The conveying section 5 includes a conveying roller 23 and a registration roller 24.

The conveying roller 23 conveys the sheet S supplied from the paper feeding roller 22a to the registration roller 24. The conveying roller 23 strikes the distal end in a conveying direction of the sheet S against a nip N of the registration roller 24.

The registration roller 24 bends the sheet S in the nip N to thereby align the position of the distal end of the sheet S in the conveying direction. The registration roller 24 conveys the sheet S according to timing when the image forming unit 3 transfers the toner image onto the sheet S.

The configuration of the image forming unit 3 is described below.

The image forming unit 3 includes a plurality of image forming sections 25, a laser scanning unit 26, an intermediate transfer belt 27, a transfer section 28, and a fixing device 29.

The image forming sections 25 include photoconductive drums 25d. The image forming sections 25 form, on the photoconductive drums 25d, toner images corresponding to an image signal received from the scanner section 2 or the outside. A plurality of image forming sections 25Y, 25M, 25C, and 25K respectively form toner images by yellow, magenta, cyan, and black toners.

Charging devices, developing devices, and the like are disposed around the photoconductive drums 25d. The charging devices charge the surfaces of the photoconductive drums 25d. The developing devices store developer containing the yellow, magenta, cyan, and black toners. The developing devices develop electrostatic latent images on the photoconductive drums 25d. As a result, toner images by the respective color toners are formed on the photoconductive drums 25d.

The laser scanning unit 26 scans a laser beam L on the charged photoconductive drums 25d to expose the photoconductive drums 25d. The laser scanning unit 26 exposes the photoconductive drums 25d of the image forming sections 25Y, 25M, 25C, and 25K of the respective colors with separate laser beams LY, LM, LC, and LK. Consequently, the laser scanning unit 26 forms electrostatic latent images on the photoconductive drums 25d.

The toner images on the surfaces of the photoconductive drums 25d are primarily transferred onto the intermediate transfer belt 27.

The transfer section 28 transfers the toner images, which are primarily transferred onto the intermediate transfer belt 27, onto the surface of the sheet S in a secondary transfer position.

The fixing device 29 applies heat and pressure to the sheet S and fixes the toner images transferred onto the sheet S.

The reversing unit 30 reveres the sheet S in order to form an image on the rear surface of the sheet S. The reversing unit 30 reverses, with switchback, the sheet S discharged from the fixing device 29. The reversing unit 30 conveys the reversed sheet S toward the registration roller 24.

The discharged sheet S, on which the image is formed, is placed on the paper discharge tray 7.

The control panel 8 is a part of an input section to which an operator inputs information for operating the image forming apparatus 1. The control panel 8 includes a touch panel and various hard keys.

The control section 6 performs control of the sections of the image forming apparatus 1.

The sheet storing device 40 is described below.

The sheet storing device 40 includes the cassette 42, a tray 44, guide members 46 (46a, 46b, and 46c), and a projecting section 50.

The cassette 42 is formed in a flat box shape and includes an opening in an upper part. The cassette 42 is capable of storing the sheets S in a state in which the sheets S are placed on the tray 44 described below. The cassette 42 is detachably attachable to the image forming apparatus 1 illustrated in FIG. 1.

As illustrated in FIG. 2, as a local coordinate system of the tray 44, an x direction, a y direction, and a z direction are defined as follows. The x direction (a first direction) is a supplying direction of the sheet S parallel to a sheet placing surface 44f of the tray 44. A +x direction is a downstream side of the supplying direction of the sheet S. They direction (a second direction) is a direction parallel to the sheet placing surface 44f of the tray 44 and orthogonal to the x direction. A center side in the y direction of the tray 44 is sometimes referred to as inner side in the y direction. The z direction is a normal direction of the sheet placing surface 44f of the tray 44. A +z direction is a direction in which the sheets S are stacked on the sheet placing surface 44f. As described below, the tray 44 is capable of turning around a turning shaft 45. The local coordinate system also turns according to the turning of the tray 44.

FIG. 3 illustrates a plan view of the sheet storing device. The tray 44 is formed of a steel plate material or the like. The tray 44 is disposed on the bottom surface on the inside of the cassette 42. The external shape of the tray 44 is slightly smaller than the external shape of the bottom surface of the cassette 42. The surface in the +z direction of the tray 44 is the sheet placing surface 44f. In FIGS. 3, 4, and 6, hatching is applied to the sheet placing surface 44f.

In FIG. 2, a circumferential direction of they direction is a θy direction. A +θy direction is a counterclockwise direction when viewed in a +y direction. The tray 44 is formed to be capable of turning in the θy direction around the turning shaft 45. The turning shaft 45 is disposed in parallel to the y direction at the end portion in a −x direction of the tray 44. The image forming apparatus 1 includes a sheet position sensor and a tray driving section (both of which are not illustrated in FIG. 2). The sheet position sensor outputs a signal corresponding to the position of the upper surface of the stacked sheets S. The control section 6 determines whether the position of the upper surface of the sheets S detected by the sheet position sensor is lower than a first predetermined position. If the position of the upper surface of the sheets S is lower than the first predetermined position, the control section 6 turns the tray 44 in the +θy direction with the tray driving section. The control section 6 disposes the position of the upper surface of the sheets S near the end portion in the +Z direction of the cassette 42. Consequently, the sheet S is taken out by the pickup roller 21.

As illustrated in FIG. 3, the tray 44 includes openings 44a, 44b, and 44c through which the guide members 46a, 46b, and 46c pass, respectively. The first opening 44a is formed at a corner of the +x direction and a −y direction of the tray 44. The second opening 44b is formed at a corner of the +x direction and the +y direction of the tray 44. The third opening 44c is formed at the end portion in the −x direction and in the center in the y direction. The openings 44a, 44b, and 44c are formed in a rectangular shape having the x direction as a longitudinal direction.

As illustrated in FIG. 2, the guide members 46a, 46b, and 46c are erected from the bottom surface of the cassette 42 through the openings 44a, 44b, and 44c of the tray 44, respectively. The guide members 46a, 46b, and 46c extend to the vicinity of the end portion in the +Z direction of the cassette 42. As illustrated in FIG. 3, the first guide member 46a and the second guide member 46b are disposed in parallel to an XZ plane and are movable in the Y direction. The first guide member 46a passes through the first opening 44a. The second guide member 46b passes through the second opening 44b. The third guide member 46c is disposed in parallel to a YZ plane and is movable in the X direction. The third guide member 46c passes through the third opening 44c.

Even if sizes of the sheets S are different, the sheets S are placed on the sheet placing surface 44f of the tray 44 in a state described below. The end side in the +x direction of the sheets S is disposed near the end side in the +x direction of the tray 44 (front alignment). The center in the y direction of the sheets S is disposed in the center in the y direction of the tray 44 (center alignment). On the sheet placing surface 44f, a region where the sheets S are placed is a sheet placing region 44s. In FIGS. 3, 4, and 6, hatching opposite to the hatching of the sheet placing surface 44f is applied to the sheet placing region 44s.

FIG. 3 illustrates a state in which the sheet S having a maximum size is placed on the sheet placing surface 44f of the tray 44. At this time, the first guide member 46a moves in the −Y direction and guides the end side in the −y direction of the sheet S. The second guide member 46b moves in the +Y direction and guides the end side in the +y direction of the sheet S. The third guide member 46c moves in the −X direction and guides the end side in the −x direction of the sheet S.

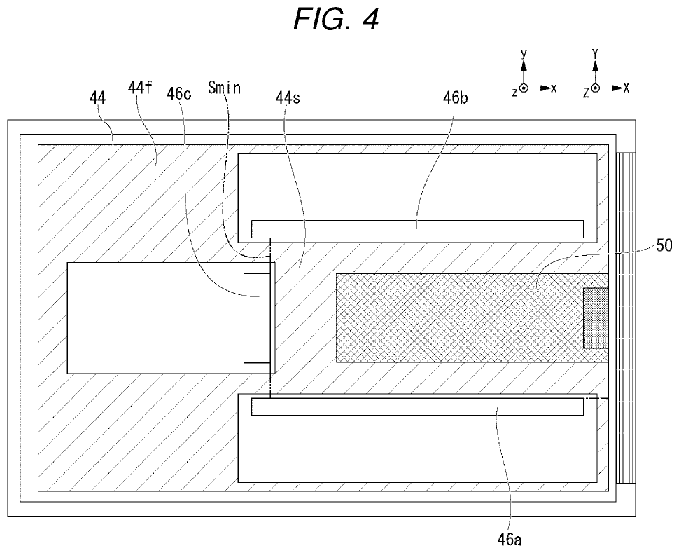

FIG. 4 illustrates a plan view of the sheet storing device. FIG. 4 illustrates a state in which a sheet Smin having a minimum size is placed on the sheet placing surface 44f of the tray 44. At this time, the first guide member 46a moves in the +Y direction and guides the end side in the −y direction of the sheet Smin. The second guide member 46b moves in the −Y direction and guides the end side in the +y direction of the sheet Smin. The third guide member 46c moves in the +X direction and guides the end side in the −x direction of the sheet Smin.

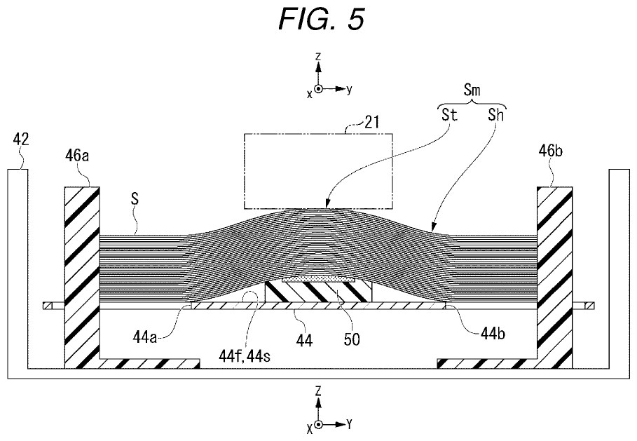

FIG. 5 illustrates a front cross-sectional view of the sheet storing device along a V-V line in FIG. 3.

The projecting section 50 is formed of a light resin material or the like. The projecting section 50 is disposed on the sheet placing surface 44f of the tray 44 and erected in the +z direction. The surface in the +z direction of the projecting section 50 is formed in an arcuate surface. The end side of the surface in the +z direction of the projecting section 50 is chamfered.

In FIGS. 3, 4, and 6, lattice-like hatching is applied to the projecting section 50. As illustrated in FIG. 3, the projecting section 50 is formed in a square shape when viewed from the z direction. The center in the y direction of the projecting section 50 is disposed in the center in they direction of the tray 44. The end portion in the +x direction of the projecting section 50 is disposed near the end side in the +x direction of the tray 44. Consequently, the projecting section 50 is disposed to overlap the pickup roller 21 when viewed from the z direction.

The projecting section 50 is disposed in the sheet placing region 44s on the sheet placing surface 44f. As illustrated in FIG. 4, even if the sheet Smin having the minimum size is placed, at least a part of the projecting section 50 is disposed in the sheet placing region 44s. In an example illustrated in FIG. 4, the projecting section 50 is disposed further on the inner side than both the end portions in the y direction of the sheet placing region 44s. That is, the entire projecting section 50 is disposed in the sheet placing region 44s.

As illustrated in FIG. 5, the sheets S placed in the sheet placing region 44s bend over the projecting section 50 provided in the sheet placing region 44s. In particular, since the entire projecting section 50 is disposed in the sheet placing region 44s, the sheets S are placed to cover the projecting section 50. Consequently, the sheets S are deformed into a mountain shape Sm. That is, a mountaintop St is formed in the +z direction of the projecting section 50. A mountain skirt Sh is formed in the +y direction and the −y direction of the projecting section 50. The sheets S hang from the mountaintop St to the mountain skirt Sh with the gravity. At this time, air intrudes among the stacked sheets S from the portion of the mountain skirt Sh of the sheets S.

The pickup roller 21 is disposed in the +Z direction of the projecting section 50. The pickup roller 21 rotates while coming into contact with the mountaintop St of the sheets S and takes out the sheets S. Since the air intrudes among the stacked sheets S, a coefficient of friction between an upper layer sheet and a lower layer sheet is small. If a conveying force acts on the upper layer sheet from the pickup roller 21, a slip occurs between the upper layer sheet and the lower layer sheet. Consequently, the pickup roller 21 can take out the sheets S one by one.

As illustrated in FIG. 3, the projecting section 50 is formed in a rectangular shape having the x direction as a longitudinal direction. That is, length D in the x direction of the projecting section 50 is larger than width W in the y direction. Consequently, the mountain shape Sm of the sheets S is formed in a wide range in the x direction. The air easily intrudes among the stacked sheets S. Therefore, the pickup roller 21 can take out the sheets S one by one.

The projecting section 50 includes a friction member 52. For example, the friction member 52 is formed of a cork material or the like. The friction member 52 is disposed on the surface in the +z direction of the projecting section 50 that is in contact with the sheet S. The friction member 52 is disposed at the end portion in the +x direction of the projecting section 50. The friction member 52 is disposed in the center in the y direction of the projecting section 50. A coefficient of friction of the surface in the +z direction of the friction member 52 is larger than a coefficient of friction of the surface of the projecting section 50 around the friction member 52.

If the remaining sheets S stacked on the tray 44 decrease, the own weight of the sheets S decreases. Therefore, a frictional force acting on the lowermost layer sheet from the projecting section 50 decreases. The friction member 52 increases the frictional force acting on the lowermost sheet. Consequently, even if the remaining sheets S decrease, the pickup roller 21 can take out upper layer sheets one by one.

As described above in detail, the sheet storing device 40 in the embodiment includes the cassette 42, the tray 44, and the projecting section 50. The cassette 42 is capable of storing the sheets S. The tray 44 is disposed on the inner side of the cassette 42 and includes the sheet placing surface 44f on which the sheets S are placed. The tray 44 is capable of supplying the sheets S in the x direction parallel to the sheet placing surface 44f. The projecting section 50 is provided in the sheet placing region 44s on the sheet placing surface 44f of the tray 44.

The sheets S placed in the sheet placing region 44s bend or pass over the projecting section 50 provided in the sheet placing region 44s and are deformed. At this time, air intrudes among the stacked sheets S. A coefficient of friction among the stacked sheets S decreases. A slip occurs between an upper layer sheet and a lower layer sheet. The pickup roller 21 can take out the sheets S one by one. Therefore, the sheet storing device 40 can prevent double feeding of sheets.

Even if the pickup roller 21 takes out two or more superimposed sheets S, the separating roller 22b illustrated in FIG. 2 prevents double feeding of the sheets S. However, if a high-friction material on the outer circumferential surface of the separating roller 22b is worn because of use in a long period, a double feeding preventing ability by the separating roller 22b decreases. Even in this case, by adopting the sheet storing device 40 in the embodiment, the pickup roller 21 can take out the sheets S one by one. Therefore, the double feeding of the sheets S is prevented.

At least a part of the projecting section 50 is disposed in the sheet placing region 44s of the sheet Smin having the minimum size.

Consequently, the projecting section 50 is disposed in the sheet placing regions 44s of all sizes. The sheet storing device 40 can prevent double feeding of the sheets S irrespective of a size of sheets stored therein.

The projecting section 50 is disposed further on the inner side than both the end portions in the y direction of the sheet placing region 44s.

Consequently, the sheets S are disposed to cover the projecting section 50 provided in the sheet placing region 44s. Consequently, the sheets S are deformed in the mountain shape Sm. Air intrudes among the stacked sheets S from the portion of the mountain skirt Sh of the sheet S. Therefore, the sheet storing device 40 can prevent double feeding of the sheets S.

The Length D in the x direction of the projecting section 50 is larger than the width W in the y direction.

Since the sheets S pass over the projecting section 50 in a wide range in the x direction, the air easily intrudes between the stacked sheets S. Therefore, the sheet storing device 40 can prevent double feeding of the sheets S.

The projecting section 50 is disposed at the end portion of the sheet placing region 44s on the downstream side in the x direction.

Consequently, a coefficient of friction among the staked sheets S decreases in a position where the pickup roller 21 takes out the sheets S. The pickup roller 21 can take out the sheets S one by one.

The sheet storing device 40 includes the friction member 52 on the surface of the projecting section 50 that is in contact with the sheet S. A coefficient of friction of the surface of the friction member 52 is larger than a coefficient of friction of the surface of the projecting section 50 around the friction member 52.

If the remaining sheets S stacked on the tray 44 decrease, a frictional force acting on the lowermost layer sheet from the projecting section 50 decreases. The friction member 52 increases the frictional force acting on the lowermost layer sheet. Consequently, even if the remaining sheets S decrease, the pickup roller 21 can take out upper layer sheets one by one.

The image forming apparatus 1 according to the embodiment includes the sheet storing device 40 described above and the image forming unit 3. The image forming unit 3 applies image processing to the sheets S conveyed from the sheet storing device 40.

The sheet storing device 40 described above can prevent double feeding of the sheets S. Therefore, the image forming apparatus 1 can prevent various troubles involved in the double feeding of the sheets S. For example, the image forming apparatus 1 can prevent a paper jam involved in the double feeding of the sheets S.

### Second Embodiment

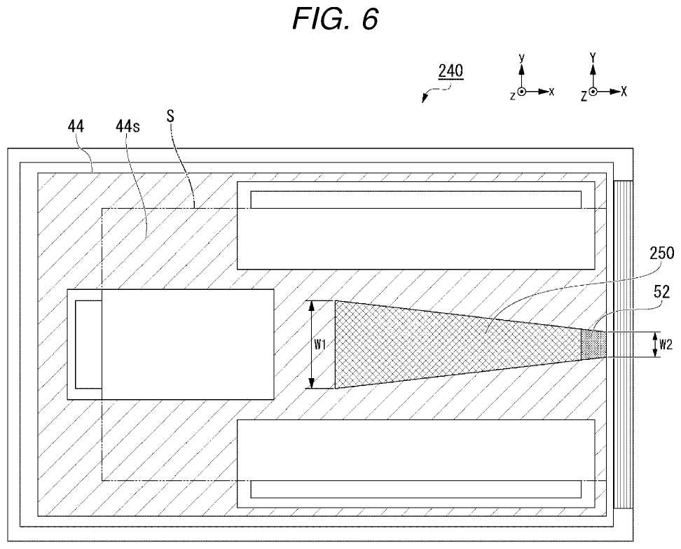

FIG. 6 illustrates a plan view of a sheet storing device according to a second embodiment. In a sheet storing device 240 in the second embodiment, a shape of a projecting section 250 is different from the shape in the first embodiment. Concerning similarities to the first embodiment, description of the second embodiment is omitted.

The width in the y direction of the projecting section 250 decreases from an upstream side to a downstream side in the x direction. That is, width W2 in the y direction at the end portion in the +x direction of the projecting section 250 is smaller than width W1 in the y direction at the end portion in the −x direction.

As in the first embodiment, the sheet storing device 240 in the second embodiment can prevent double feeding of the sheets S.

In particular, the center in the y direction of the projecting section 250 is disposed in the center in the y direction of the sheet placing region 44s of the tray 44. The end portion in the +x direction of the projecting section 250 is disposed near the end side in the +x direction of the sheet placing region 44s of the tray 44. Consequently, air intrudes among the stacked sheets S right under the pickup roller 21 (in the −z direction). The pickup roller 21 can easily take out the sheets S one by one. Therefore, the sheet storing device 240 can effectively prevent double feeding of the sheets S.

### Third Embodiment

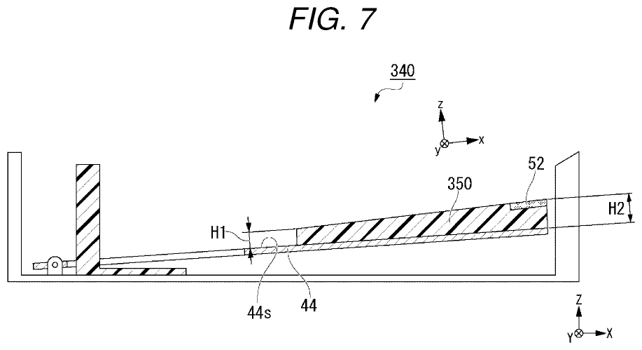

FIG. 7 illustrates a side cross-sectional view of a sheet storing device in a third embodiment. FIG. 7 illustrates a cross-sectional view in a portion corresponding to the II-II line in FIG. 3. In a sheet storing device 340 in the third embodiment, a shape of a projecting section 350 is different from the shape in the first embodiment. Concerning similarities to the first embodiment, description of the third embodiment is omitted.

The height in the z direction of the projecting section 350 increases from the upstream side to the downstream side in the x direction. That is, height H2 in the z direction at the end portion in the +x direction of the projecting section 350 is larger than height H1 in the z direction at the end portion in the −x direction.

As the projecting section 350 is higher, deformation of the sheets S placed on the projecting section 350 is larger. Air more easily intrudes among the stacked sheets S. Therefore, the sheet storing device 340 in the third embodiment can prevent double feeding of the sheets S.

In particular, the center in the y direction of the projecting section 350 is disposed in the center in the y direction of the sheet placing region 44s of the tray 44. The end portion in the +x direction of the projecting section 350 is disposed near the end side in the +x direction of the sheet placing region 44s of the tray 44. Consequently, the height of the projecting section 350 increases right under the pickup roller 21 (in the −z direction). Therefore, the sheet storing device 340 can effectively prevent double feeding of the sheets S.

### Fourth Embodiment

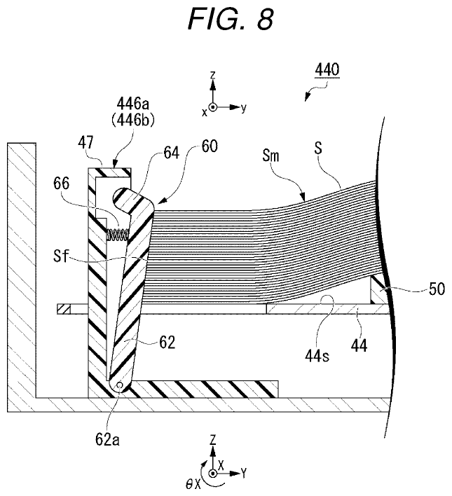

FIG. 8 illustrates an enlarged view of a front cross section of a sheet storing device in a fourth embodiment. FIG. 8 is an enlarged view of a left half portion of a cross section in a portion corresponding to a V-V line in FIG. 3. A sheet storing device 440 in the fourth embodiment is different from the first embodiment in the configuration of a first guide member 446a and a second guide member 446b. Concerning similarities to the first embodiment, description of the fourth embodiment is omitted. The first guide member 446a and the second guide member 446b are plane-symmetrical with respect to the XZ plane set as a symmetry plane. The first guide member 446a is representatively described below.

The first guide member 446a includes a main body section 47 and an inclined guide 60. The main body section 47 is disposed in parallel to the XZ plane.

The inclined guide 60 is formed of a resin material or the like. The inclined guide 60 includes a guide section 62, a lead-in section 64, and a spring member 66.

The height in the Z direction of the guide section 62 is slightly smaller than the height of the main body section 47. The guide section 62 may be formed in the same length as the main body section 47 along the X direction or may be formed only at the end portion in the +X direction.

In FIG. 8, the circumferential direction of the X direction is a θX direction. A +θX direction is a clockwise direction when viewed in the −X direction. The guide section 62 is capable of turning in the θX direction around a turning shaft 62a with respect to the main body section 47. The turning shaft 62a is disposed in parallel to the X direction at the end portion in the −Z direction of the main body section 47 and the guide section 62. Consequently, the guide section 62 can vary a position on the inner side in they direction along the Z direction. The main body section 47 restricts a turning limit in a −θX direction of the guide section 62. If the guide section 62 turns to the turning limit in the −θX direction, the guide section 62 is housed on the inside of the main body section 47.

The spring member 66 is an example of an elastic member. The spring member 66 is disposed between the main body section 47 and the guide section 62. The spring member 66 urges the guide section 62 in the +θX direction. The spring member 66 restricts a turning limit in the +θX direction of the guide section 62 in a state in which the spring member 66 is completely stretched.

As described above, if the sheets S are placed to cover the projecting section 50, the sheets S are deformed in the mountain shape Sm. At this time, the width in the y direction of the stacked sheets S decreases from the −z direction to the +z direction. That is, an end face Sf in the y direction of the stacked sheets S is an inclined surface inclined with respect to the XZ plane. The guide section 62 is urged by the spring member 66 in the +θX direction and comes into contact with the end face Sf of the sheets S. Consequently, the guide section 62 guides the sheet S along the inclination of the end face Sf of the stacked sheets S. Therefore, the sheet storing device 440 can stably store the sheets S.

The lead-in section 64 extends in the +Z direction and the −Y direction from the end portion in the +Z direction of the guide section 62. That is, the lead-in section 64 obliquely extends toward the upper direction of the sheet storing device 440 and the outer side in the Y direction.

If the sheets S are not placed on the tray 44, the guide section 62 projects to the inner side in the Y direction of the sheet placing region 44s with an urging force of the spring member 66. If the sheets S are placed in the sheet placing region 44s, the sheets S push the lead-in section 64 to the −Z direction. Consequently, the lead-in section 64 turns in the −θX direction together with the guide section 62. The guide section 62 is housed on the inside of the main body section 47. Therefore, the sheets S are placed in the sheet placing region 44s without being blocked by the guide section 62.

As described in detail above, the sheet storing device 440 includes the first guide member 446a. The first guide member 446a is disposed on the outer side of the sheet placing region 44s in the y direction. The guide section 62 of the first guide member 446a is capable of varying a position on the inner side of the y direction along the Z direction.

If the sheets S are placed to cover the projecting section 50, the end face Sf of the stacked sheets S is inclined. The guide section 62 guides the sheet S along the inclination of the end face Sf of the stacked sheets S. Therefore, the sheet storing device 440 can stably store the sheets S.

In the embodiments described above, even if the sizes of the sheets S are different, the center in the y direction of the sheets S coincide with the center in the y direction of the tray 44. In other examples, an edge portion in the y direction of the sheets S of different sizes may be disposed to coincide with the edge portion in the y direction of the tray 44.

The disclosed sheet storing devices in the examples are applied to an image forming apparatus 1, which is an example of the image processing apparatus. In other examples, the disclosed sheet storing devices may be applied to a decoloring apparatus, which is another example of the image processing apparatus. A decoloring apparatus performs processing for decoloring images formed on the sheet S with decolorable toner.

According to at least one embodiment described above, the sheet processing apparatus 40 includes the projecting section 50 provided in the sheet placing region 44s on the sheet placing surface 44f of the tray 44. Consequently, the sheet storing device 40 can prevent double feeding of the sheets S.

While certain embodiments have been described these embodiments have been presented by way of example only, and are not intended to limit the scope of the inventions. Indeed, the novel embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sheet storing device, comprising:
a sheet cassette for storing sheets; and
a sheet tray at an inner bottom surface of the sheet cassette and rotatable around a shaft that is located along one end of the inner bottom surface in a sheet feed direction, wherein
the sheet tray has an upper surface on which the sheets are to be stored, the upper surface having a projection extending from a first end of the sheet tray towards a second end of the sheet tray that is coupled to the shaft, such that the sheets on the upper surface are disposed in an upward convex shape above the projection.

2. The sheet storing device according to claim 1, wherein a first part of an upper surface of the projection at the first end of the sheet tray has a friction coefficient higher than a friction coefficient of a second part of the upper surface of the projection more towards the second end of the sheet tray than the first part.

3. The sheet storing device according to claim 1, wherein the projection is a separate member from a main body of the sheet tray.

4. The sheet storing device according to claim 1, wherein a length of the projection in the sheet feed direction is greater than a width of the projection in a sheet width direction crossing the sheet feed direction.

5. The sheet storing device according to claim 1, wherein
the sheet tray includes a first opening and a second opening at ends of the sheet tray in a sheet width direction crossing the sheet feed direction,
the sheet storing device further comprises:
a first movable sheet guide through the first opening and movable in the sheet width direction; and
a second movable sheet guide through the second opening and movable in the sheet width direction, and
the projection is between the first opening and the second opening.

6. The sheet storing device according to claim 5, wherein
the first movable sheet guide includes a first rotatable guide member that is rotatable around a first shaft, the first shaft being at a position below the upper surface of the sheet tray and extending in a sheet feed direction, the first rotatable guide member being mechanically urged towards the sheets, and
the second movable sheet guide includes a second rotatable guide member that is rotatable around a second shaft, the second shaft being at a position below the upper surface of the sheet tray and extending in a sheet feed direction, the second rotatable guide member being mechanically urged towards the sheets.

7. The sheet storing device according to claim 5, wherein
the sheet tray further includes a third opening,
the sheet storing device further comprises a third movable sheet guide through the third opening and movable in the sheet feed direction, and
the projection is between the third opening and the first end of the sheet tray.

8. The sheet storing device according to claim 7, wherein a width of the projection in the sheet width direction is less than a width of the third opening in the sheet width direction.

9. The sheet storing device according to claim 1, wherein an upper surface of the projection has a upward convex shape in a sheet width direction crossing the sheet feed direction.

10. The sheet storing device according to claim 1, further comprising:
a sheet feed roller configured to feed an uppermost one of the sheets out of the sheet storing device, wherein
at least part of the projection faces the sheet feed roller.

11. The sheet storing device according to claim 1, wherein a width of the projection in a sheet width direction crossing the sheet feed direction decreases as approaching the first end of the sheet tray.

12. The sheet storing device according to claim 1, wherein a height of the projection above a main part of the sheet tray increases as approaching the first end of the sheet tray.

13. An image forming apparatus, comprising:
an image forming device; and
a sheet storing device configured to feed a sheet to the image forming device,
the sheet storing device comprising:
a sheet cassette for storing sheets; and
a sheet tray at an inner bottom surface of the sheet cassette and rotatable around a shaft that is located along one end of the inner bottom surface in a sheet feed direction, wherein
the sheet tray has an upper surface on which the sheets are to be stored, the upper surface having a projection extending from a first end of the sheet tray towards a second end of the sheet tray that is coupled to the shaft, such that the sheets on the upper surface are disposed in an upward convex shape above the projection.

14. The image forming apparatus according to claim 13, wherein
the sheet tray includes a first opening and a second opening at ends of the sheet tray in a sheet width direction crossing the sheet feed direction,
the sheet storing device further comprises:
a first movable sheet guide through the first opening and movable in the sheet width direction; and
a second movable sheet guide through the second opening and movable in the sheet width direction, and
the projection is between the first opening and the second opening.

15. The image forming apparatus according to claim 14, wherein
the first movable sheet guide includes a first rotatable guide member that is rotatable around a first shaft, the first shaft at a position below the upper surface of the sheet tray and extending in a sheet feed direction, the first rotatable guide member being mechanically urged towards the sheets, and
the second movable sheet guide includes a second rotatable guide member that is rotatable around a second shaft, the second shaft at a position below the upper surface of the sheet tray and extending in a sheet feed direction, the second rotatable guide member being mechanically urged towards the sheets.

16. The image forming apparatus according to claim 14, wherein
the sheet tray further includes a third opening,
the sheet storing device further comprises a third movable sheet guide through the third opening and movable in the sheet feed direction, and
the protrusion is provided between the third opening and the first end of the sheet tray.

17. An image decoloring apparatus, comprising:
an image decoloring device; and
a sheet storing device configured to feed a sheet to the image decoloring device, wherein
the sheet storing device comprises:
a sheet cassette for storing sheets; and
a sheet tray at an inner bottom surface of the sheet cassette and rotatable around a shaft that is located along one end of the inner bottom surface in a sheet feed direction, wherein
the sheet tray has an upper surface on which the sheets are to be stored, the upper surface having a projection extending from a first end of the sheet tray towards a second end of the sheet tray that is coupled to the shaft, such that the sheets on the upper surface are disposed in an upward convex shape above the projection.

18. The image decoloring apparatus according to claim 17, wherein
the sheet tray includes a first opening and a second opening at ends of the sheet tray in a sheet width direction crossing the sheet feed direction,
the sheet storing device further comprises:
a first movable sheet guide through the first opening and movable in the sheet width direction; and
a second movable sheet guide through the second opening and movable in the sheet width direction, and
the projection is between the first opening and the second opening.

19. The image decoloring apparatus according to claim 18, wherein
the first movable sheet guide includes a first rotatable guide member that is rotatable around a first shaft, the first shaft at a position below the upper surface of the sheet tray and extending in a sheet feed direction, the first rotatable guide member being mechanically urged towards the sheets, and
the second movable sheet guide includes a second rotatable guide member that is rotatable around a second shaft, the second shaft at a position below the upper surface of the sheet tray and extending in a sheet feed direction, the second rotatable guide member being mechanically urged towards the sheets.

20. The image decoloring apparatus according to claim 18, wherein
the sheet tray further includes a third opening,
the sheet storing device further comprises a third movable sheet guide through the third opening and movable in the sheet feed direction, and
the projection is between the third opening and the first end of the sheet tray.
